(19) United States
(12) Patent Application Publication
(10) Pub. No.: US 2014/0048973 A1
(43) Pub. Date: Feb. 20, 2014

(54) METHOD FOR RATIONALISING PRODUCTION OF DISPENSERS

(71) Applicants: Frida Gustavsson, Goteborg (SE); Gustav Groth, Goteborg (SE)

(72) Inventors: Frida Gustavsson, Goteborg (SE); Gustav Groth, Goteborg (SE)

(73) Assignee: SCA HYGIENE PRODUCTS AB, GOTEBORG (SE)

(21) Appl. No.: 14/114,238

(22) PCT Filed: Apr. 29, 2011
(86) PCT No.: PCT/SE11/50536

§ 371 Date: Oct. 28, 2013

(51) Int. Cl. B29C 45/00

(52) U.S. Cl. CPC B29C 45/0053
USPC 264/132

(57) ABSTRACT

Disclosed is a method for rationalising production of a first series of first identical dispensers and a second series of second identical dispensers. The first identical dispensers are different from the second identical dispensers, except for: each of the first and second identical dispensers is constituted by a housing formed at least by a first and a second distinguishable component which abut each other. The first and second distinguishable components together form a motif-receiving surface which has a first region having a first change-in-depth-per-unit-width ratio of at least 0.25. The method includes injection-moulding the first and second distinguishable components; providing a motif on a transfer medium, and applying the motif to at least the first region of the motif-receiving surface to transfer the motif from the transfer medium to the motif-receiving surface, with the motif occupying a rectangular area of at least 30 cm² on the motif-receiving surface.

### TECHNICAL FIELD

The present disclosure relates to a method for rationalising production of a first series of first identical dispensers and a second series of second identical dispensers.

### BACKGROUND

Washroom facilities are commonly equipped with dispensers, often made of plastic, for non-reusable products that are associated with personal hygiene. Such products include liquid or foam soaps, toilet tissue, facial tissue and hand towels. Each type of product requires a dedicated type of dispenser. As such, the different types of dispenser have differing shapes and sizes.

Particularly for dispensers that are to be used in publicly accessible washroom facilities, high demands are placed not only on the robustness of the dispensers but also on their appearance. Manufacturers of dispensers therefore seek to provide aesthetically pleasing, ergonomically designed dispensers. Furthermore, where it can be expected that different types of dispenser will be present in the same area, manufactures seek to impart a common trait on the dispensers so that the dispensers may be perceived as belonging to a family of dispensers. In this manner, the fittings in a washroom may appear more harmonized.

For reasons of economy, dispensers used in washroom facilities are refillable. To assist cleaning staff in identifying when a dispenser needs to be refilled before it is completely depleted, dispensers are commonly provided with means for ascertaining the remaining amount or volume of the product without the need to open up the dispenser. Often, such means are in the form of an inspection window through which the product may be viewed. To mitigate any detrimental effect an inspection window may have on the appearance of a dispenser, the inspection window may be formed as a translucent panel extending across substantially the entire width of the dispenser, with the translucent panel being coloured to complement the colour(s) of the remainder of the dispenser. By utilizing the same colours for the different types of dispenser, the desired common trait can be imparted to a family of dispensers.

A further way of imparting a common trait to a family of dispensers is to provide a plurality of loose inserts of different colours or designs which can be snapped into suitably dimensioned openings in the dispensers.

Other than using snap-in inserts and different coloured materials for constituent components of dispensers, to date if it has been desired to provide a plastic dispenser with a decoration this has been done by spray painting, for example in silver, or applying a logo on a small region of the dispenser. Recently, it has been proposed to use a water transfer technique to obtain continuous patters resembling wood grain, marble, water droplets, etc. Water transfer is a technology with low precision and high labour intensity and the patters are applied to one single plastic part at a time. This technology is therefore unsuited to mass production of multi-part products for which a common family trait is required.

There is therefore a need for a method of attaining a common trait in a family of dispensers using a motif that can overlie two adjacent components of the dispensers whilst being easily applied to dispensers of different shapes and sizes. The method should permit rationalization of the production of series of identical dispensers of a family of dispensers by allowing, when desired, the same motif to be applied to all dispensers.

### SUMMARY

The above-mentioned need is attained by a method for rationalising production of a first series of first identical dispensers and a second series of second identical dispensers. The first identical dispensers are different to the second identical dispensers, for example in size and/or shape, though the dispensers have at least the following common attributes: each of the first identical dispensers and the second identical dispensers is constituted by a housing formed at least by a first and a second distinguishable component which abut each other; the first and said second distinguishable components together form a motif-receiving surface, with the motif-receiving surface having a first region having a first change-in-depth-per-unit-width ratio of at least 0.25. The method comprises the steps of:

injection-moulding the first and second distinguishable components;
providing a motif on a transfer medium, and
applying the motif to at least the first region of the motif-receiving surface to thereby transfer the motif from the transfer medium to the motif-receiving surface, the motif occupying a rectangular area of at least 30 cm² on the motif-receiving surface.

With the above method, a common family trait in the form of a motif extending over curved surfaces of the dispensers can be imparted on the first and second series of dispensers in a reliable and repeatable fashion.

By the expression “distinguishable component” it is meant that a person is able to visually determine a separation or transition line between two adjacent components of a dispenser. A separation or transition line may be enhanced by using different colours for the adjacent components.

The expression “change-in-depth-per-unit-width” is a measure of the curvature of a region of a surface and is determined in the following manner.

With reference to FIG. 1, a dispenser 10 is laid on its wall-mounting surface 12 and a rectangle R is drawn around the dispenser with one side of the rectangle being coincident with the wall-mounting surface 12. The rectangle defines a depth direction D perpendicular to the wall-mounting surface and a width direction W parallel to the wall-mounting surface. The width direction W corresponds to the transverse extension of the dispenser, i.e. the extension of the dispenser in the horizontal direction parallel to the wall when the dispenser is mounted on a wall. For any region on the envelope surface of the dispenser it is possible to determine by measurement a change in depth d for a given measure of width w, for example 1.0 cm. The change-in-depth-per-unit-width ratio is given by d:w.

The rectangular area that a motif occupies on the motif-receiving surface is determined in the following manner.

With reference to FIGS. 2A to 2C, the printed motif is transposed to a flattened state so as to correspond to the motif on the transfer medium. A rectangle is then fitted around the motif so that, for each side of the rectangle, at least one point on the motif touches the respective side and no part of the motif crosses any side of the rectangle. It will be apparent that, for some motifs, it may be possible to fit a plurality of rectangles around the motif. Thus, in FIG. 2A two possible rectangles R1 and R2 are drawn around the motif M. For the rectangle R1, the motif M has points M1, M2, M3 and M4, each of which touches a respective side of the rectangle. For the rectangle R2, the corresponding points are labeled as M5, M6, M7 and M8. It will be noted that in this particular case M4 and M8 coincide. Irrespective of the number of rectangles which may be fitted around a motif, the requirement of the claim that the motif occupies a rectangular area of at least 30 cm² on the motif-receiving surface is fulfilled if the rectangle of smallest area has an area of at least 30 cm². In FIG. 2B, the motif M has five points (M1 to M5) which touch the sides of the rectangle R, with points M2 and M3 both touching the same side of the rectangle. In FIG. 2C, the motif M has 9 points (M1 to M9) which touch the sides of the rectangle R, with points M8 and M9 both touching the same side of the rectangle. On the opposite side of the rectangle, the points M2 to M6 are constituted by regions of the motif M which terminate at the side of the rectangle.

Should the dispenser be provided, in addition to the motif, with a logo, for example indicating a trade name, then the logo is not to be regarded as a part of the motif.

In a first aspect, the first region has a first change-in-depth-per-unit-width ratio of no more than 1.5, preferably no more than 1.0.

According to embodiments the transfer medium is a heat transfer foil or a décor film or the transfer medium comprises a pad of a pad printing system.

According to embodiments the method further comprises the step of uniting the first and second distinguishable components prior to said step of applying said motif.

According to embodiments the first region is located on the first distinguishable component and the motif extends over a second region of the motif-receiving surface, with the second region being located on the second distinguishable component.

According to embodiments, at least for the first series of first identical dispensers, the print-receiving surface has a third region having a second change-in-depth-per-unit-width ratio of no more than 0.1. As such, this third region is less curved than the first region.

According to embodiments the transfer medium comprises a plurality of pads of a pad printing system. The plurality of pads may be sequentially applied to the motif-receiving surface, either to impart different colours to the motif and/or to cover a greater area of the motif-receiving surface. For dispensers on which it is desired to provide a motif which extends a substantial distance in the depth direction D of the dispenser, it can be advantageous to rotate the dispenser to which the motif is applied about at least one axis of rotation between application of the pads.

According to embodiments the step of injection-moulding the first and second distinguishable components takes place sequentially in a common mould.

According to embodiment the motif applied to each of the first identical dispensers of the first series is directly related to the motif applied to each of the second identical dispensers of said second series.

In this respect, the expression “directly related” means that the motifs on each of the dispensers of the first and second series of dispensers are:
identical in colour, shape and size; or
identical in colour and shape but the motif on the second series of dispensers being a scaled version of the motif on the first series of dispensers.

The expression “directly related” is also intended to cover situations in which the motif applied to each of the second identical dispensers of the second series is constituted by one or more components of the motif applied to each of the first identical dispensers of the first series. In this respect, the expression “one or more components” means that the motif includes one or more identifiable elements which are common to the motifs of both the first series and second series. Such elements may, for example, include a leaf, a wavy line, a depiction of a flower or tree, etc.

### BRIEF DESCRIPTION OF THE DRAWINGS

Embodiments of the invention will be described in the following by way of example only and with reference to the attached drawings in which:

FIG. 1 is a diagram illustrating how the change-in-depth-per-unit-width ratio is determined;

FIGS. 2A to 2C illustrate how motifs used on dispensers in the method according to an embodiment of the present invention may occupy a rectangle;

FIG. 3 is a schematic perspective view of a dispenser belonging to a first series of first identical dispensers;

FIG. 4 is a schematic perspective view of a dispenser belonging to a second series of second identical dispensers;

FIGS. 5A to 5D are schematic drawings of a first type of equipment suitable for carrying out the method according to an embodiment of the present invention;

FIGS. 6A and 6C schematically illustrate a second type of equipment suitable for carrying out the method according to an embodiment of the present invention, and

FIGS. 7A and 7B schematically illustrate a third type of equipment suitable for carrying out the motif-application step of the method according to an embodiment of the present invention.

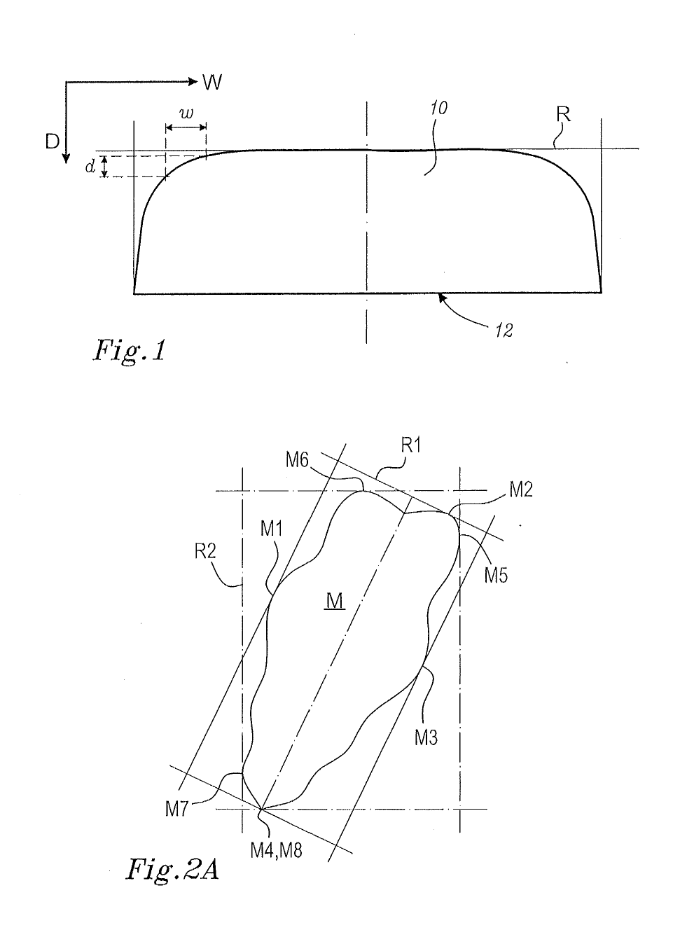

### DETAILED DESCRIPTION OF EMBODIMENTS

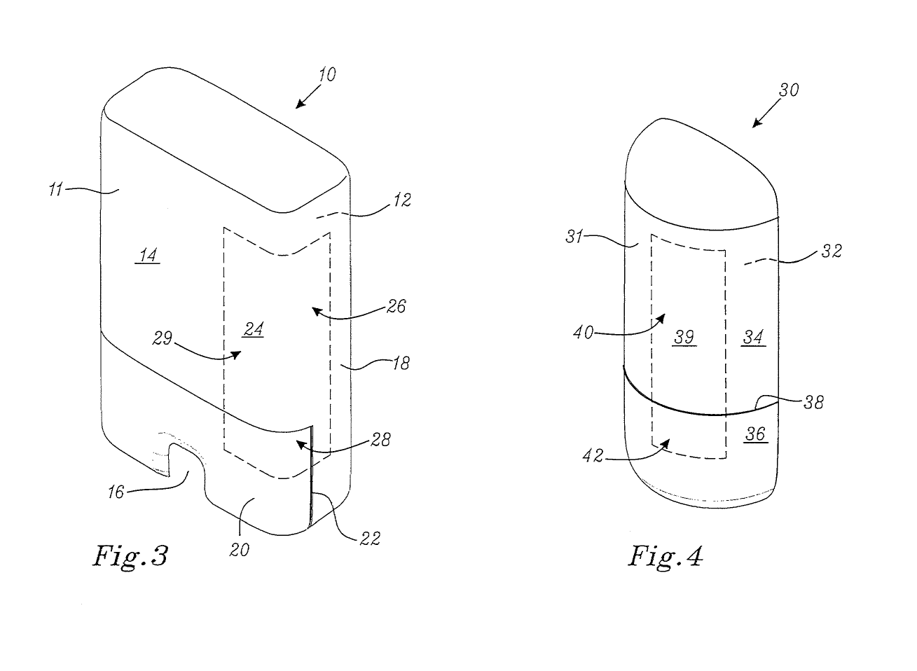

With reference to FIG. 3, reference number 10 generally denotes a dispenser belonging to a first series of first identical dispensers. The dispenser 10 has a housing 11 provided with a wall-mounting surface 12 to allow the dispenser to be fixed to a wall or the like. Purely by way of example the dispenser 10 may be used to dispense paper towels (not shown) from a stack of towels accommodated within the dispenser. On a side of the housing 11 opposite to the wall-mounting surface, i.e. on the front side 14, the dispenser may be provided with a user access opening 16 to permit a user to grasp a towel and withdraw it from the housing via a not-shown dispensing opening at the base of the dispenser. A type of dispenser suitable for this purpose is that sold under the name Tork Elevation H2.

The housing 11 is formed from at least a first and a second distinguishable component 18, 20. The first and the second distinguishable components abut each other along an abutment line 22. For the Tork Elevation H2 dispenser, the first and the second distinguishable components 18, 20 are injection-moulded sequentially in one and the same mould. However, it is to be understood that the present disclosure also pertains to dispensers the first and second distinguishable components of which are formed separately and then assembled to form a housing of a dispenser. In addition to the first and second distinguishable components, the dispenser may also include a not-shown wall mounting plate forming a rear wall of the dispenser. The wall-mounting plate may be screwed directly to a wall or the wall may be firstly provided with a wall bracket to which the wall-mounting plate may subsequently be attached. In the illustrated embodiment the first distinguishable component 18 forms a majority of the housing which is visible in use, with the second distinguishable component 20 forming a lower region at least partially delimiting the dispensing opening. Accordingly, the user access opening 16 is formed in the second distinguishable component 20. To facilitate a determination of when the dispenser 10 may need to be replenished with a stack of paper towels, the second distinguishable component may be made from a translucent or semi-translucent material so that the lowermost paper towels of a stack within the housing may be seen from the outside of the dispenser.

The first and the second distinguishable components 18, 20 together form a motif-receiving surface 24 depicted by dashed lines in FIG. 3. In manners which will be described below, the motif-receiving surface receives a motif from a transfer medium such as a heat transfer foil or a décor film, or a pad of a pad printing system. To enhance the appearance of the dispenser 10, the motif-receiving surface extends over a first region generally denoted by reference number 26 which is curved such that it has a first change-in-depth per unit width ratio as defined previously herein of at least 0.25. In certain example embodiments, the first region 26 has a first change-in-depth per unit width ratio of no more than 1.5, preferably no more than 1.0. The inventors have found that dispensers having a curved first region falling within the stipulated intervals allow the use of motif-transfer techniques which lend themselves to accurate reproduction at high production speeds. To further enhance the appearance of the dispenser, the motif which is applied to at least the first region 26 of the motif-receiving surface 24 occupies a rectangular area of at least 30 cm². In example embodiments the first region 26 is located on the first distinguishable component 18 and the motif extends over a second region, generally denoted by reference number 28, which is located on the second distinguishable component 20 such that the motif gives at least the impression of extending over the abutment line 22 between the first and second distinguishable components 18, 20.

Similarly, in FIG. 4 reference number 30 generally denotes a dispenser belonging to a second series of second identical dispensers. The dispenser 30 has a housing 31 provided with a wall-mounting surface 32 to allow the dispenser to be fixed to a wall or the like. Purely by way of example the dispenser 10 may be used to dispense liquid or foam soap. A type of dispenser suitable for this purpose is that sold under the name Tork Elevation S1.

As with the dispenser of the first series of first identical dispensers, the housing 31 of the dispenser of the second series of second identical dispensers is formed from at least a first and a second distinguishable component 34, 36. The first and the second distinguishable components abut each other along an abutment line 38. For the Tork Elevation S1 dispenser, the first and the second distinguishable components 34, 36 are injection-moulded sequentially in one and the same mould. However, it is to be understood that the present disclosure also pertains to dispensers the first and second distinguishable components of which are formed separately and then assembled to form a housing of a dispenser. In the illustrated embodiment the first distinguishable component 34 forms a majority of the housing which is visible in use, with the second distinguishable component 36 forming a lower region. A not-shown soap dispensing mechanism projects from the second distinguishable component 36 and is connected to a container of soap within the housing 31. The container may be refillable or may be replaceable. To facilitate a determination of when the dispenser 30 may need to be replenished with soap, the second distinguishable component 36 may be made from a translucent or semi-translucent material so that the level of soap within the container of soap may be seen from the outside of the dispenser.

The first and the second distinguishable components 34, 36 together form a motif-receiving surface 39 depicted by dashed lines in FIG. 4. In manners which will be described below, the motif-receiving surface receives a motif from a transfer medium such as a heat transfer foil or a décor film, or a pad of a pad printing system. To enhance the appearance of the dispenser 30, the motif-receiving surface extends over a first region generally denoted by reference number 40 which is curved such that it has a first change-in-depth per unit width ratio as defined previously herein of at least 0.25. In certain example embodiments, the first region 40 has a first change-in-depth per unit width ratio of no more than 1.5, preferably no more than 1.0. To further enhance the appearance of the dispenser, the motif which is applied to at least the first region 40 of the motif-receiving surface 39 occupies a rectangular area of at least 30 cm². In example embodiments the first region 40 is located on the first distinguishable component 34 and the motif extends over a second region, generally denoted by reference number 42, which is located on the second distinguishable component 36 such that the motif gives at least the impression of extending over the abutment line 38 between the first and second distinguishable components 34, 36.

Reverting to FIG. 3, in example embodiments the print-receiving surface 24 of the dispenser 10 of at least the first series of first identical dispensers has a third region 29 having a second change-in-depth-per-unit-width ratio of no more than 0.1. This means that the motif extends over both a relatively flat surface constituted by the third region 29 and a more curved surface constituted by the first region 26. Whether the dispensers of the second series of second identical dispensers have such a third region will depend on the required shape of the containers for the intended type of product to be dispensed.

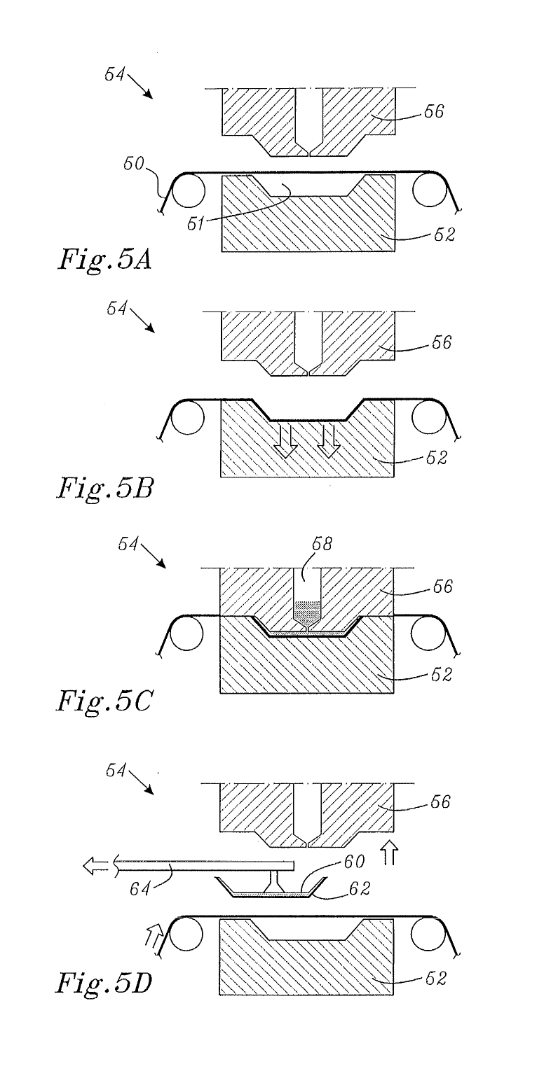

Non-limitative techniques for carrying out the method according to some embodiments of the present invention will be described in the following with reference to FIGS. 5 to 7.

FIGS. 5A to 5D illustrate steps in a so-called In-Mould Decoration, or IMD, process in which a motif is applied to a component during injection moulding of the component. The motif to be transferred to the component is provided on a transfer medium 50 in the form of a continuous film or transfer foil. As shown in FIG. 5A, the transfer medium 50 is arranged to at least partially cover a mould cavity 51 formed in a female section 52 of an injection-moulding mould 54. As depicted by arrows in FIG. 5B. a suction force is applied to the transfer medium to cause the transfer medium to be held against the female section 52 of the mould 54. The mould is then closed by bringing the male section 56 of the mould into a moulding position (FIG. 5C) and injection of molten resin into the mould cavity 51 then takes place by means of one or more injectors 58. The resin subsequently solidifies to form a component 60 onto which a motif 62 from the transfer medium 50 has been applied. The mould 54 is opened (FIG. 5D) and a robot arm 64 is introduced to remove the thus-formed component 60 with motif 62. The continuous film or transfer foil is then advanced to bring a next region bearing the desired motif into register with the female section 52 of the mould 54 and the sequence of steps is repeated.

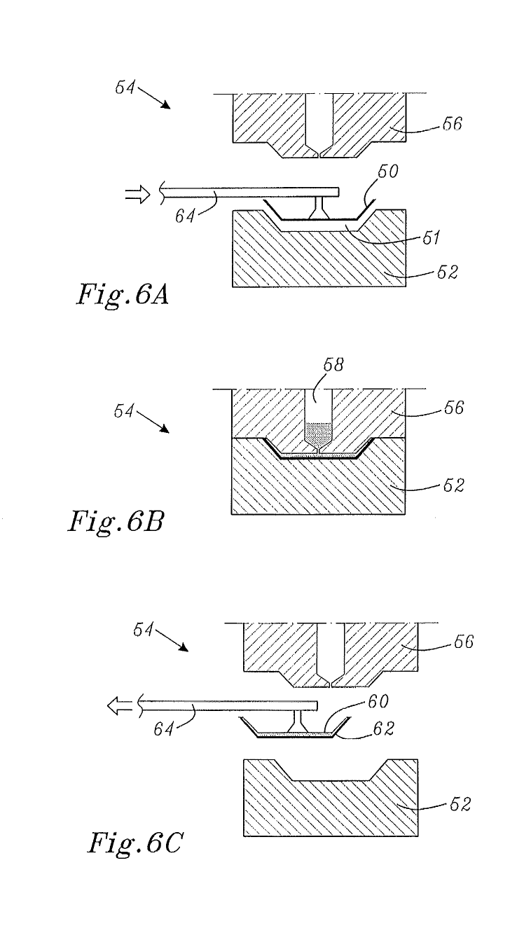

A modification of the IMD process is illustrated in FIGS. 6A to 6C in which, rather than being in the form of a continuous film or transfer foil, the transfer medium 50 is in the form of individual sheets, with one sheet being used per mould cycle. Thus, in FIG. 6A a robot arm 64 introduces a single sheet of the transfer medium 50 into the mould cavity 51 formed in the female section 52 of the mould 54 whence it is held in place by suitable means, such as suction. The mould is then closed by bringing the male section 56 of the mould into a moulding position (FIG. 6B) and injection of molten resin then takes place by means of the injector(s) 58. The resin subsequently solidifies to form a component 60 onto which a motif 62 from the transfer medium 50 has been applied. The mould 54 is opened (FIG. 6C) and the robot arm 64 is reintroduced to remove the thus-formed component 60 with motif 62.

It will be understood that the above-described process for forming a component 60 in a single injection of molten resin may easily be modified to permit sequential injection-moulding by using a core to initially blank off a section of the mould cavity. A first component, for example corresponding to the previously described first distinguishable component 18, 34, is then formed. The mould is then opened, the core removed, the mould closed and a second component, for example corresponding to the previously described second distinguishable component 20, 36, is then formed.

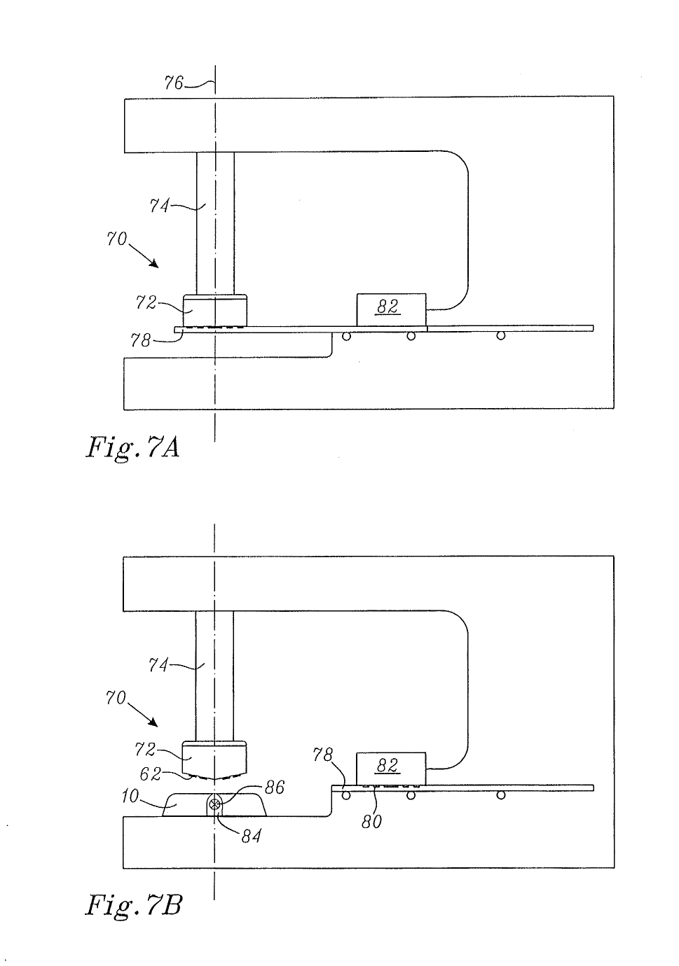

A further technique suitable for carrying out the method in one embodiment of the invention in which the first and second distinguishable components have already been brought into abutment with each other is illustrated in FIGS. 7 A and 7B. In these drawings reference number 70 generally denotes one station of a so-called tampon or pad printing system. The pad printing system 70 includes one or more transfer pads 72 made of a deformable material such as silicone rubber. Each transfer pad 72 is supported by a pad carrier member 74 capable of performing a reciprocating movement along a generally vertically arranged axis 76. The tampon printing system further comprises a flat cliché plate 78 having an upper surface which is provided with a relief 80 corresponding to the motif to be transferred to an object to be printed. Printing ink is applied to the cliché plate by means of an ink reservoir 82. With reference to FIG. 7A, it can be seen how the transfer pad 72 is brought into contact with the cliché plate 78 to transfer the motif from the plate to the transfer pad. The motif on the transfer pad is schematically illustrated in FIG. 7B and denoted by reference number 62. As can further be gleaned from FIG. 7B, the cliché plate is reciprocally displaceable in the generally horizontal direction between a first position at which motif transfer to the pad 72 takes place and a second position at which the relief on the cliché plate is charged with ink from the ink reservoir 82. When the cliché plate 78 is in its second position, an object to be printed, in this case the first dispenser 10, is brought by means of a support member 84 into position below the transfer pad 72 so that its motif-receiving surface is aligned with the motif 62 on the transfer pad. The transfer pad 72 is then lowered to transfer the motif 62 from the pad to the first dispenser 10. Thereafter, the cycle is repeated with a new dispenser.

To permit printing on any region of the motif-receiving surface which extends a substantial distance in the depth direction D of the container 10, the support member 84 may be provided with one or more axes of rotation 86 about which the dispenser may be rotated to thereby bring that region of the motif-receiving surface closer to the transfer pad 72. In FIG. 7B the axis of rotation is shown as extending along the longitudinal axis of the container, i.e. perpendicular to the depth D and width W directions of the dispenser. However, it is to be understood that the support member 84 may be designed such that rotation about an axis in any chosen direction may be attained.

For coloured motifs, several stations 70 may be provided in series such that the transfer pad of each station prints a different colour, with the colours being applied sequentially.

Furthermore, for practical reasons it may be suitable to print only a portion of the motif-receiving surface at one station and to print the remaining portion at one or more subsequent stations.

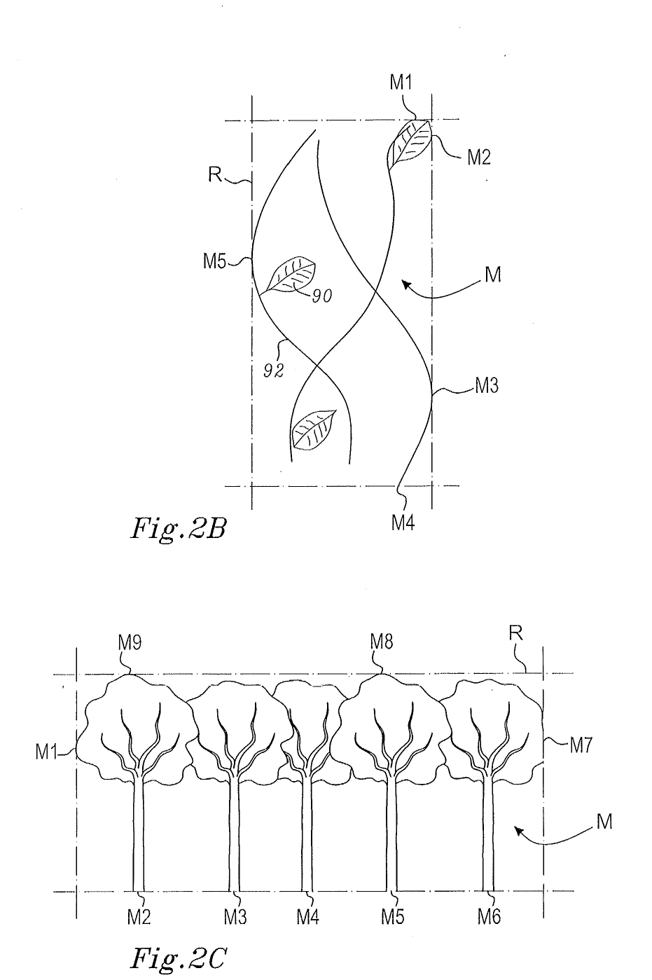

It is to be understood that the motif 62 may be of any design. Nevertheless, in order to impart a family trait to the series of first and second identical dispensers the motif applied to each of the first identical dispensers of the first series may directly related to the motif applied to each of the second identical dispensers of the second series. Non-limitative examples of possible motifs are illustrated in FIGS. 2A to 2C and identified by the letter M. Thus, the motifs on each of the dispensers of the first and second series of dispensers may be identical in terms of colour, shape and size. This implies that substantially the same equipment may be used to apply the motifs to the dispensers of both series.

For the cases in which the dispensers of the first series of first identical dispensers differ significantly in size compared to the dispensers of the second series of second identical dispensers, it may be beneficial to use motifs which are identical in colour and shape, but in which the motif on the second series of dispensers is a scaled version of the motif on the first series of containers.

As previously explained, the expression “directly related” is also intended to cover situations in which the motif applied to each of the second identical dispensers of the second series is constituted by one or more components of the motif applied to each of the first identical dispensers of the first series. In this respect, the expression “one or more components” means that the motif includes one or more identifiable elements which are common to the motifs of both the first series and second series. With reference to FIG. 2B, such elements may, for example, include a leaf 90 or a wavy line 92.

It is to be understood that the present disclosure is not limited to the embodiments described above and illustrated in the drawings, but may be varied within the scope of the appended claims. Thus, the inventive concept may be applied to all members of a family of dispensers irrespective of the number of different family members.

1. A method for rationalising production of a first series of first identical dispensers and a second series of second identical dispensers, said first identical dispensers being different from said second identical dispensers, though having at least the following common attributes:
each of said first identical dispensers and said second identical dispensers is constituted by a housing formed at least by a first and a second distinguishable component which abut each other, said first and said second distinguishable components together forming a motif-receiving surface, said motif-receiving surface having a first region having a first change-in-depth-per-unit-width ratio of at least 0.25, and
said method comprising:
injection-moulding said first and second distinguishable components;
providing a motif on a transfer medium, and
applying said motif to at least said first region of said motif-receiving surface to thereby transfer said motif from said transfer medium to said motif-receiving surface, said motif occupying a rectangular area of at least 30 cm² on said motif-receiving surface.

2. The method as claimed in claim 1, wherein said first region (26; 40) has a first change-in-depth-per-unit-width ratio of no more than 1.5.

3. The method as claimed in claim 1, wherein said transfer medium is one of a heat transfer foil and a décor film.

4. The method as claimed in claim 1, wherein said transfer medium comprises a pad of a pad printing system.

5. The method as claimed in claim 1, further comprising uniting said first and second distinguishable components prior to applying said motif.

6. The method as claimed in claim 1, wherein said first region is located on said first distinguishable component and said motif extends over a second region of said motif-receiving surface, said second region being located on said second distinguishable component.

7. The method as claimed in claim 1, wherein at least for said first series of first identical dispensers, said print-receiving surface has a third region having a second change-in-depth-per-unit-width ratio of no more than 0.1.

8. The method as claimed in claim 4, wherein said transfer medium comprises a plurality of pads of a pad printing system.

9. The method as claimed in claim 8, wherein said plurality of pads are sequentially applied to said motif-receiving surface.

10. The method as claimed in claim 9, further comprising rotating the dispenser to which the motif is applied about at least one axis of rotation between application of pads.

11. The method as claimed in claim 1, wherein said injection-moulding said first and second distinguishable components takes place sequentially in a common mould.

12. The method as claimed in claim 1, wherein the motif applied to each of said first identical dispensers of said first series is directly related to the motif applied to each of said second identical dispensers of said second series.

13. The method as claimed in claim 12, wherein the motif applied to each of said second identical dispensers of said second series is a scaled version of the motif applied to each of said first identical dispensers of said first series.

14. The method as claimed in claim 12, wherein the motif applied to each of said second identical dispensers of said second series is constituted by one or more components of the motif applied to each of said first identical dispensers of said first series.

15. The method as claimed in claim 1, wherein said first region has a first change-in-depth-per-unit-width ratio of no more than 1.0.

16. The method as claimed in claim 13, wherein the motif applied to each of said second identical dispensers of said second series is constituted by one or more components of the motif applied to each of said first identical dispensers of said first series.
